(19) United States
(12) Patent Application Publication
(10) Pub. No.: US 2020/0319687 A1
(43) Pub. Date: Oct. 8, 2020

(54) PRINTED CIRCUIT BOARD WITH AT LEAST ONE MULTIPOLE PIN HEADER, COMPUTER SYSTEM AND OPERATING METHOD

(71) Applicant: Fujitsu Technology Solutions Intellectual Property GmbH, Munchen (DE)

(72) Inventors: Waldemar Felde, Munchen (DE); Rudolf Haussermann, Munchen (DE); Rainer Staude, Munchen (DE)

(21) Appl. No.: 16/837,584

(22) Filed: Apr. 1, 2020

(30) Foreign Application Priority Data
Apr. 5, 2019 (DE) 102019109016.4

(51) Int. Cl. G06F 1/26

(52) U.S. Cl. CPC G06F 1/26; H01R 12/716

(57) ABSTRACT

A printed circuit board includes at least one multipole pin header with at least one first pin contact and a second pin contact arranged adjacent to the first pin contact and connected to a first predetermined reference potential, at least one evaluation circuit electrically connected to the first pin contact and arranged for this purpose, detecting the application of a predetermined voltage level at the first pin contact, and a safety circuit electrically connected to the at least one evaluation circuit, which is arranged to prevent a complete voltage supply to the printed circuit board when the evaluation circuit detects the application of the predetermined voltage level at the first pin contact.

### TECHNICAL FIELD

This disclosure relates to a printed circuit board comprising at least one multipole pin header and at least one evaluation circuit electrically connected to a first pin contact of the pin header, as well as a computer system comprising at least one system board and at least one connection board for connecting an external peripheral device and an operating method for a computer system.

### BACKGROUND

Known computer systems generally have a plurality of printed circuit boards, in particular in the form of a system board and one or more further boards connected thereto, which are connected to one another via various plug connections. For reasons of cost and space saving, multipole pin headers and corresponding cable connectors are often used to connect boards. Such connectors are also known as post headers or post connectors.

Multipole pin headers have a number of mechanically similar pin contacts in a fixed pitch and thus make it possible to connect a number of lines of different boards with each other. The problem with such connectors is that it is relatively easy for the corresponding cable connectors to be incorrectly connected when they are placed on the pin header. For example, it is possible to place a cable connector on a corresponding pin header with one or more pin contacts offset or turned by 180°.

Incorrect connection of a cable connector to a corresponding pin header can be mechanically prevented by surrounding the actual pin header with a rectangular border, typically made of plastic, which is mechanically designed so that a corresponding cable connector can only be placed on the pin header in a predetermined orientation. For this purpose, projections or recesses are typically provided on the sides of the cable connector and the border. A plug connector mechanically coded in this way is usually referred to as a tub connector since the border surrounds the actual electrical contacts of the pin header in a tub-like manner. The problem with this approach is that the provision of the additional border increases the space requirement of the plug connector. In addition, the insertion forces are also increased when the cable connector is inserted into the border, which in turn can lead to damage to a circuit board during insertion.

It could therefore be helpful to provide improved devices and methods that enable a cable connector to be securely connected to a plug connector in the form of a pin header.

### SUMMARY

We provide a printed circuit board including at least one multipole pin header with at least one first pin contact and a second pin contact arranged adjacent to the first pin contact and connected to a first predetermined reference potential, at least one evaluation circuit electrically connected to the first pin contact and configured to detect the application of a predetermined voltage level to the first pin contact, and a safety circuit electrically connected to the at least one evaluation circuit and configured to prevent a complete voltage supply to the printed circuit board when the evaluation circuit detects the application of the predetermined voltage level to the first pin contact.

We also provide a method of operating a computer system, including providing a standby voltage, checking whether a first pin contact of a multi-pin header of a system component of the computer system is electrically connected to a predetermined voltage potential, providing a normal supply voltage to start further components of the computer system if the first pin contact is not connected to the predetermined voltage potential, and aborting the starting procedure and preventing the normal supply voltage from being provided at the multipole plug connector if the first pin contact is connected to the predetermined voltage potential.

### BRIEF DESCRIPTION OF THE DRAWINGS

FIG. 1 shows a plug connector with a first multipole pin header and a cable connector mounted offset.

FIG. 2 shows a computer system according to a first example.

FIG. 3 shows a connection scheme for a double row pin header that connects two USB ports according to a first example

FIG. 4 is a flowchart of an operating method for the computer system according to FIG. 2.

### REFERENCE SIGNS

1 pin header
2 cable connector
3 pin contact
4 printed circuit board
5 computer system
6 power supply unit
7 system board
8 connection board
9 power sequencing controller
10 chipset
11 processor
12 interface module
13 USB plug connector
14 Ribbon cable
15 line
16 input port
17 pull-up resistor
18 control line
A1-A10 connection point
B1-B8, B10 socket
D, D+, D− data line
GND ground potential
S1-S6 process steps
VCC (normal) supply voltage
VSTBY standby voltage

### DETAILED DESCRIPTION

Our printed circuit board may comprise at least one multipole pin header with at least one first pin contact and a second pin contact arranged adjacent to the first pin contact and connected to a first predetermined reference potential. The printed circuit board may further comprise at least one evaluation circuit electrically connected to the first pin contact, which is configured to detect application of a predetermined voltage level to the first pin contact, and a safety circuit electrically connected to the at least one evaluation circuit, which is configured to prevent complete power supply to the printed circuit board when the evaluation circuit detects application of the predetermined voltage level to the first pin contact.

By providing and monitoring an electrical connection of a first pin contact with respect to a predetermined voltage level, an offset plugging of a cable connector onto a multipole pin header can be detected. We make use of the fact that, for example, all components of an electrical device are usually connected to a common ground potential that can be used as a predetermined reference potential. If the additional, first pin contact is connected to the reference potential by offset placement of the cable connector, this potential can be detected by the evaluation circuit and damage to the circuit board can be averted by preventing activation or power supply to the circuit board.

The printed circuit board may further comprise at least one interface circuit, wherein at least a third pin contact of the multipole pin header is connected to a data line of the interface circuit, at least a fourth pin contact arranged adjacent to the third pin contact is connected to a supply line of the printed circuit board, and the safety circuit is configured to prevent provision of a supply voltage via the supply line if the evaluation circuit detects the application of the predetermined voltage level to the first pin contact. Such a printed circuit board prevents in particular the connection of data lines of an interface circuit to a supply voltage and thus possible damage to the interface circuit or peripheral devices connected thereto.

The pin header may be a double or multi-row pin header and additionally include at least one coding that prevents a 180° rotated attachment of an appropriately coded cable connector. By evaluating the voltage level of the first pin contact, it is possible to detect in particular an offset placement of a cable connector. If the plug connection is additionally mechanically coded, for example, by omitting one or more pin contacts of the pin header, a twisted attachment of the cable plug can also be prevented. In contrast to known tub connectors, this does not require a complete border around the pin header.

Each row of the double-row or multi-row pin header may include a plurality of pin contacts that provide one data connection each. Such arrangements are particularly common for connecting multiple ports of a USB connection board.

A first row of the double or multi-row header may comprise a plurality of pin contacts that provide a first data connector and the at least one coding. A second row of the double or multi-row header may comprise a second plurality of pin contacts that provides a second, similar data connector and the first pin contact. Due to the symmetrical design of the multi-row pin header with respect to the first and second data connector, offset placement of a cable connector in a direction transverse to a longitudinal direction of the header does not result in damage to the components of the printed circuit board.

Our computer system may comprise:

a system board, in particular in the form of a printed circuit board according to the first aspect, having at least one interface device, at least one multipole pin header electrically connected to the at least one interface device, and a control circuit; and

at least one connection board with at least one internal plug connector to connect the connection board to the at least one multipole pin header of the system board and at least one external plug connector to connect a peripheral device,

wherein the control circuitry is configured to prevent full activation of the system board when a predetermined voltage level is applied to a first pin contact of the at least one multipole pin header.

The computer system may in particular allow detection of a cable connection between a system board and a connection board of a computer system that is connected in a staggered manner

The control circuit may comprise at least one pull-up resistor, the first pin contact connected to a standby voltage via the pull-up resistor. The control circuit may be configured to prevent provision of a normal supply voltage if the first pin contact is connected to a ground potential of the connection board via an incorrectly connected cable connector. By providing a pull-up resistor, the first pin contact can be easily set to a first, high voltage level. If the first pin contact is then pulled to a different voltage potential, especially the ground potential, by offsetting a cable connector, this can be detected by the control circuit.

The system board may further comprise a chipset and a power sequencing controller, wherein the first pin contact is connected to an input port of at least part of the chipset, and the power sequencing controller scans the voltage level at the input port when the computer system is started and activates a normal supply voltage for all components of the system board only if the voltage level indicates that the first pin contact is not electrically connected to a predetermined voltage potential of the connection board. The components typically provided on a system board, in particular a chipset and a power sequencing controller, can be used to implement the above-mentioned control circuit with little additional circuitry by adapting their firmware accordingly.

The system board may further comprise signaling means that indicates an error when starting the computer system, wherein the control circuit is adapted to signal an error when the predetermined voltage level is applied to the first pin contact. For example, in a so-called Power-On-Self-Test (POST), a corresponding error code can be output, indicating to a fitter or user of the computer system that a cable connector has been incorrectly plugged onto the pin header.

The at least one internal plug connector of the connection board may be a multipole pin header wired equivalent to the at least one multipole pin header of the system board, and the at least one multipole pin header of the system board may be connected to the multipole pin header of the connection board via a cable connection. Due to the symmetrical design of the two plug connectors, a single control circuit can be used to detect offset placement of a cable connector on both ends of a cable connection.

The connection board may have a plurality of internal plug connectors and all the ground connections of the internal plug connectors may be connected to each other. If the ground connection is provided by one of the other internal plug connectors, an incorrectly exposed cable connector can still be detected even if the connection board is not directly connected to a ground contact, for example, a housing wall of the computer system.

Our operating method for a computer system, in particular the above computer system may comprise the following steps:

providing a standby voltage;

checking whether a first pin contact of a multipole pin header of a system component of the computer system is electrically connected to a predetermined voltage potential;

providing a normal supply voltage to start further components of the computer system if the first pin contact is not connected to the predetermined voltage potential; and

aborting the starting procedure and preventing the normal supply voltage from being provided at the multipole plug connector if the first pin contact is connected to the predetermined voltage potential.

By following the above steps, a computer system startup can be interrupted early enough to prevent damage to the computer system caused by an incorrectly placed cable connector. In addition, the boot interruption can be used to indicate that a cable connector has been incorrectly attached to a multipole plug connector.

The step of checking may be performed by a power sequencing controller or a BIOS program as part of a power-on self-test, POST, of the computer system.

Further advantages are disclosed in the following description of examples. Our printed circuit boards, systems and methods are described in detail by various examples with reference to the appended figures. The same reference signs are used for similar components of different examples. Different instances of similar components are indicated by an alphabetical suffix if necessary.

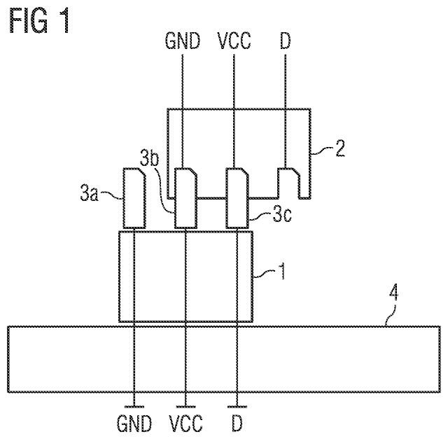

FIG. 1 shows—by a first plug connector—several possible problems with the offset placement of a cable connector 2 on a pin header 1. In the example shown in FIG. 1, pin header 1 comprises only three pin contacts 3a to 3c arranged next to each other. A ground potential GND is provided via the first pin contact 3a, a supply voltage VCC is provided via the second pin contact 3b. The third pin contact 3c is connected to a data line D of an interface circuit of a PCB 4 not shown in FIG. 1.

If the cable connector 2 is placed on the pin header 1 as shown in FIG. 1, offset to the right by one pin contact 3, the cable-side ground connection is effectively connected to the second pin contact 3b and the cable-side supply voltage connection to the third pin contact 3c. This is problematic in several ways. Assuming that a component connected to the cable connector 2 is connected to the same ground potential GND via a common housing or other electrical connection as the PCB 4 on which the pin header 1 is placed, an electrical short circuit occurs between the pin contact 3b and the ground connection of the cable connector 2. If the supply voltage VCC is also provided via the cable connector 2, which may occur in particular if another board or component is connected to the PCB 4 via different plug connectors, the supply voltage VCC is also coupled to the data line D via the third pin contact 3c. In many configurations, this leads to the destruction of any underlying electronics, especially the interface circuitry. Even if the described system is not damaged, the interface connection cannot be used successfully in the situation shown in FIG. 1. It is therefore desirable to detect an offset placement of the cable connector 2 on pin header 1 as early as possible.

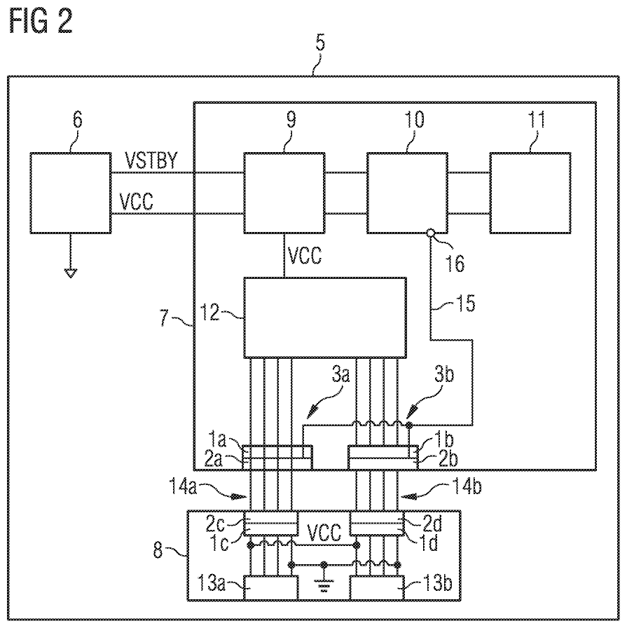

FIG. 2 shows a computer system 5 according to an example. The computer system 5 comprises a power supply unit 6, a system board 7 and a connection board 8, for example, in the form of a so-called front panel. The power supply unit 6 provides, inter alia, a standby voltage VSTBY and a supply voltage VCC for the normal operation of the computer system 5. These two voltages are fed to a so-called power sequencing controller 9 of the system board 7. The power sequencing controller 9 provides one or both of these voltages to further components of the system board 7, for example, a chipset 10, a processor 11 and an interface module 12, according to control signals and predetermined time sequences.

Interface module 12 is a so-called USB host controller. The interface module 12 is connected via a total of eight lines to the connection board 8 and two USB plug connectors 13a and 13b arranged on it. Each of the USB plug connectors 13a and 13b includes a connection for the supply voltage VCC, for the ground potential GND and for a positive and negative differential data line D+ and D− respectively. In the example shown, all components of computer system 5 are additionally connected to the ground potential GND via an electrically conductive housing not shown in FIG. 2.

The system board 7 and the connection board 8 electrically connect to each other via two ribbon cables 14a and 14b, respectively. On the side of the system board 7 there are two first multi-pin headers 1a and 1b, into which two corresponding first cable connectors 2aand 2b are plugged. On the side of the connection board 8 there are two second multipole pin headers 1c and 1d, into which two corresponding second cable connectors 2c and 2d are plugged. To detect problems at an early stage when the cable connectors 2 are offset on the multi-pin headers 1, at least the first headers 1a and 1b include at least one first pin contact 3a, which connects via a line 15 to an input port 16, for example, a programmable input/output port 16 of the chipset 10.

If cable connectors 2a and 2b are correctly fitted, line 15 and the first pin contact 3a connected to it on the side of the connection board 8 are not electrically connected. This can be detected by the chipset 10 and, for example, passed on to the power sequencing controller 9 in the form of an appropriate control signal. If the power sequencing controller 9 detects a start request, for example, by pressing a power button of the computer system 5 not shown in FIG. 2, it requests the corresponding control signal. If the pin contact 3a on the side of the connection board 8 is not connected to a predetermined electrical potential, the power sequencing controller 9 switches the normal supply voltage VCC through to the other components of computer system 5.

However, if the cable connector 2 is offset on the pin header 1 such that the first pin contact 3a is connected to a predetermined potential, this is detected by the chipset 10 and signaled to the power sequencing controller 9 by a corresponding control signal. For example, it can be detected that the first pin contact 3a is connected directly to ground potential GND or indirectly via a data line D+ or D− and a pull-down resistor to ground potential GND.

The power sequencing controller 9 can thus detect that the cable connector 2 is incorrectly connected to the pin header 1 and prevents activation of the normal supply voltage VCC to avoid possible damage, for example, to the interface module 12 or the power supply unit 6. In other words, the computer system 5 does not react in the usual way to a power-up attempt. If this happens, for example, during final assembly of computer system 5, an assembler will be notified at this early stage that computer system 5 has been incorrectly assembled. Of course, a user of computer system 5 can also recognize that computer system 5 has been incorrectly assembled, for example, after opening and partially disassembling and reassembling computer system 5.

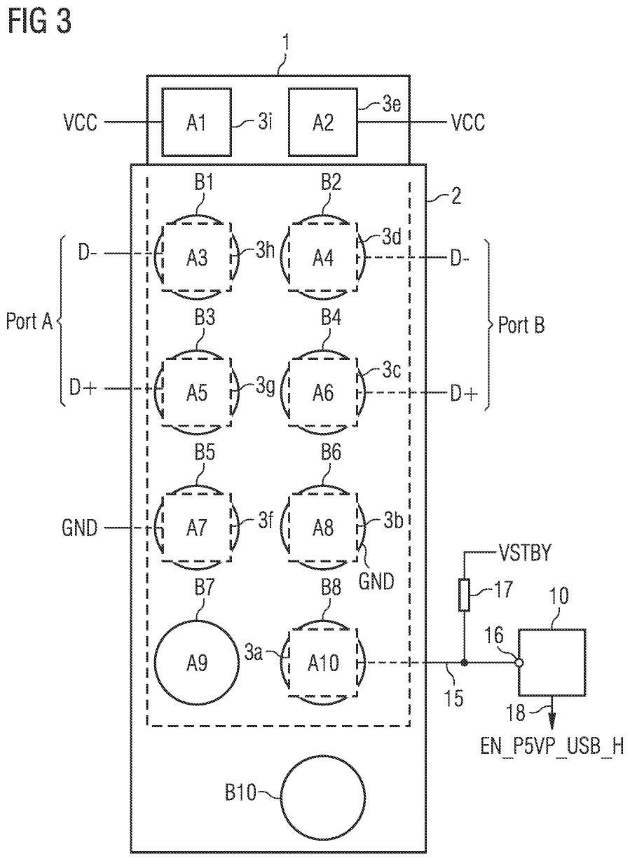

FIG. 3 shows a plug connector known per se in the form of a double-row pin header 1 with a total of ten connection points A1 to A10 for the common connection of two USB ports (referred to as “Port A” and “Port B” in FIG. 3). Such plug connectors represent a de facto industry standard and are wired as described below.

For ease of reference, the individual connection points of pin header 1 are labeled A1 to A10 from top right to bottom left. At each of the connection points A1 to A8 and A10 a rectangular pin contact 3 as shown in FIG. 3 is provided. The pin contacts 3i, 3h, 3g and 3f in the area of the connection points A1, A3, A5 and A7 of the left-hand row of pin header 1 in FIG. 3 are used to connect a first USB plug connector 13a (port A) and the pin contacts 3e, 3d, 3c and 3b to the right in the area of the connection points A2, A4, A6 and A8 are used to connect a second USB plug connector 13b (port B). No pin contact is provided in the area of the ninth connection point A9. Omitting the corresponding pin contact serves to code the plug connection as described below. Deviating from known arrangements, the pin contact 3a in the area of connection point A10 is connected to an evaluation circuit via a line 15. As described below, the evaluation circuit is used to detect an offset plugging of a cable plug 2 onto the pin header 1.

Possible errors when plugging the cable plug 2 or other plug connector onto the pin header 1 shown in FIG. 1 are described below. The cable connector 2 has nine sockets B1 to B8 and B10, which are shown in FIG. 3 in the same grid dimension as the pin contacts 3 of the pin header 1. In the area of connection point A9 there is no socket or opening in the cable connector 2 so that it is not possible to place the cable connector 2 on the pin header 1 with an angle of 180°.

A remaining type of error is the vertically offset plugging of the cable connector 2 onto the pin header 1 as shown in FIG. 3. An upward offset plugging of the cable connector 2 is not possible due to the mechanical coding of the pin header 1 and the cable connector 2. For example, in an upward offset by one pin contact, the closed opening of the cable plug 2 meets the pin contact 3f in the area of connection point A7.

However, it is possible to mount the cable connector 2 with a downward offset of one pin contact as shown in FIG. 3. In this example, connection points A1 and A2, which provide the supply voltage VCC, remain free. The corresponding sockets B1 and B2 of cable connector 2 are connected to pin contacts 3h and 3d for the negative differential data line D− in the area of connection points A3 and A4. Sockets B3 and B4 of cable connector 2, which are actually intended for these data lines, are connected to pin contacts 3g and 3c at connection points A5 and A6 to provide the positive differential data lines D+. The sockets B5 and B6 of cable connector 2 provided for these signals, on the other hand, are connected to pin contacts 3f and 3b at connection points A7 and A8 for connection to the ground potential GND. The left-hand ground contact of socket B7 of cable connector 2, shown in FIG. 3, is not connected at all since no corresponding pin contact is provided in the area of connection point A9. The right ground contact of the socket B8 of cable connector 2, on the other hand, is connected to pin contact 3a in the area of connection point A10, which is not assigned in a typical USB plug connector. The last remaining socket B10 of cable connector 2 protrudes over pin header 1, downwards in FIG. 3.

A cable connector 2 thus mounted can cause problems if, among other things, supply voltage is made available via cable connector 2 from the sides of an active peripheral device such as a USB hub, via the top two sockets B1 and B2. In this example, this voltage is coupled back into the data lines D− of the interface building block 12 via the pin contacts 3h and 3d in the area of the connection points A3 and A4. Since the driver circuits for data lines of such interface building blocks 12 are normally not voltage proof, this usually leads to a destruction of the interface building block 12. The same problem can also occur if, as shown in FIG. 2, several USB ports are connected to a system board 7 via separate connectors. If a connection between the different supply voltage lines is then provided in the area of the connection board 8, the supply voltage VCC is also fed back via connection points A3 and A4.

The same error also occurs if the cable connector 2 is plugged onto the pin header 1 with a downward offset of two rows of pins, then with respect to the data lines D+ of the pin contacts 3g and 3c.

A last possible error when plugging the cable connector 2 onto pin header 1 can occur when trying to plug the cable connector 2 onto pin header 1 offset either one pin contact to the left or right. Due to the mechanical coding, it is not possible to place the cable plug 2 on the pin header 1 with a right offset, because the closed socket at the bottom left of the cable plug 2 would then meet the pin contact 3a in the area of the bottom right connection point A10. On the other hand, it is possible to position the cable connector 2 on the pin header 1 with a left offset. Due to the symmetrical wiring of the two rows of pin contacts arranged next to each other with respect to the two USB connections, this would not cause a serious error. For example, only the contacts of the first USB connector (port A) would be connected to the corresponding contacts of the second external USB plug connector 13b.

Thus, plugging in cable connector 2 with one or more rows of pins displaced downwards poses the greatest risk of a faulty assembly.

To reliably detect this possible type of error, FIG. 3 additionally shows an evaluation circuit according to an example. The pin contact 3a in the area of the tenth connection point A10 is connected to the input port 16 of chipset 10 via line 15. To generate a predetermined voltage level at the pin contact 3a or the input port 16, line 15 is also connected via a pull-up resistor 17 to a positive voltage potential, in the design example of the standby voltage VSTBY.

If the cable connector 2 is now placed on the pin header 1 as described above, offset downwards by one row of pins, the connector socket B8 connects the pin contact 3a in the area of the tenth connection point A10 with the ground potential GND of the connection board 8. Typically, all ground potentials of all boards and other electrical components of a computer system 5 are connected with each other. Thus, typically a ground contact of the connection board 8 is also connected to the ground potential of the system board 7 via further cable connections and/or a housing contact. Accordingly, line 15 is connected to the ground potential GND via the pin contact 3a and the attached cable connector 2. The voltage at input port 16 drops from the level of the standby voltage VSTBY to a low voltage potential, which can be detected by the chipset 10. The state detected at input port 16 is signaled to other components of computer system 5 via a control line 18 and a corresponding control signal EN_P5VP_USB_H as shown in FIG. 3. In particular, the mentioned control signal can be signaled to a power sequencing controller 9, which then prevents provision of a normal supply voltage VCC for the system board 7.

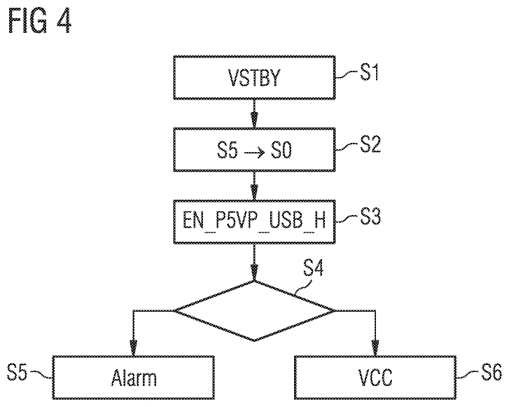

The individual steps of a procedure for starting the computer system 5 according to FIG. 2 are schematically shown in FIG. 4.

In a step S1 a standby voltage VSTBY is provided. This happens, for example, when the computer system 5 is connected to the mains voltage for the first time or a mechanical switch of the power supply 6 is switched on. After the standby voltage VSTBY has been provided, the standby voltage VSTBY is applied to the power sequencing controller 9 and, if necessary, to other parts of the computer system 5, in particular parts of the chipset 10 necessary for the activation of the computer system 5.

In this state, computer system 5 waits for an activation signal, for example, activation of a power button. If such an event is detected in a step S2, the chipset 10 signals the desired change of state, for example, from a standby state (ACPI S5) to the normal operating state (ACPI S0), to the power sequencing controller 9 via a suitable control signal. Of course, it is also possible for the sequencing controller 9 to start the computer system automatically after the mains voltage is applied.

In a step S3, the power sequencing controller 9 queries the status of input port 16, for example, by reading out control line 18, and in a subsequent decision step S4 checks whether the control signal EN_P5VP_USB_H indicates that cable connector 2 has been placed on pin header 1 with one or more rows of pins offset downwards.

If this is the example, step S5 stops the startup process of computer system 5. Optionally a corresponding alarm signal can be generated. In any event, the power sequencing controller 9 interrupts a sequence to provide the normal supply voltage VCC. Thus, further components of computer system 5, especially interface module 12 and components not required in the standby mode such as processor 11 remain disconnected from the power supply.

If, on the other hand, it is recognized in step S4 that the programmable input port 16 is at a high voltage level, i.e., the cable connector 2 is either correctly placed on pin header 1 or no cable connector at all is connected to pin header 1, there is no danger when activating the system board 7. In this example, the supply voltage VCC is switched through to the other components of the system board 7 in step S6 and the computer system 5 is started as usual after performing further tests, if necessary.

The above-mentioned circuit and error detection procedure can still detect a faulty insertion of the cable connector 2 on pin header 1 even if the cable connector 2 is placed on pin header 1 according to FIG. 3 with two or three rows of pins offset downwards. In this example, the connector sockets B6 or B4 of the differential data line D+ or D− are connected to pin contact 3a in the area of connection point A10. At least when a peripheral device such as a keyboard or mouse is connected to the corresponding USB port, these data lines are typically connected to ground potential GND via a pull-down resistor. If the pull-up resistor 17 is dimensioned accordingly, this faulty connection can still be detected by the circuit shown in FIG. 3. The only thing that could not be detected in this way would be if the cable connector 2 was plugged onto the pin header 3 with a four-row downward offset. In practice, however, this is not to be expected, since in this example only socket B2 of cable connector 2 would be connected to pin contact 3a of pin header 1.

By the measures described above, a faulty assembly of a computer system 5 can be detected particularly easily and reliably. To do this, it is only necessary to switch on the computer system 5 once after assembly is complete. If the computer system 5 does not start as expected, an assembler can immediately recognize that the computer system 5 has been assembled incorrectly and subject it to a further check. At the same time, possible damage to the computer system 5 is avoided, since the corresponding components are not supplied with a supply voltage at all.

What is claimed is:

1. A printed circuit board comprising:
at least one multipole pin header with at least one first pin contact and a second pin contact arranged adjacent to the first pin contact and connected to a first predetermined reference potential;
at least one evaluation circuit electrically connected to the first pin contact and configured to detect the application of a predetermined voltage level to the first pin contact; and
a safety circuit electrically connected to the at least one evaluation circuit and configured to prevent a complete voltage supply to the printed circuit board when the evaluation circuit detects the application of the predetermined voltage level to the first pin contact.

2. The printed circuit board according to claim 1, further comprising at least one interface circuit, wherein
at least one third pin contact of the multipole pin header is connected to a data line (D−) of the interface circuit;
at least one fourth pin contact arranged adjacent to the third pin contact is connected to a supply line of the circuit board; and
the safety circuit is configured to prevent a supply voltage from being provided via the supply line if the evaluation circuit detects the application of the predetermined voltage level at the first pin contact.

3. The printed circuit board according to claim 1, wherein the pin header is a double-row or multi-row pin strip and additionally comprises at least one coding that prevents a cable plug, which is rotated by 180°, from being placed on top of it.

4. The printed circuit board according to claim 3, wherein each row of the double-row or multi-row pin header comprises a plurality of pin contacts that provide one data connection each.

5. The printed circuit board according to claim 4, wherein
a first row of said double- or multiple-row header comprises a first plurality of pin contacts that provides a first data connection and comprises at least one coding; and
a second row of said double- or multi-row pin header comprises a second plurality of pin contacts that provides a second, similar data connection and said first pin contact.

6. The printed circuit board according to claim 1, wherein
the pin header is a double-row pin header with nine pin contacts;
in the first row of the pin header connection points 1, 3, 5 and 7 consecutively side by side as well as a coding are provided;
connection points 2, 4, 6, 8 and 10 are provided consecutively next to each other in the second row of the pin header;
the connection points 1 and 2 are connected to a supply voltage line of the printed circuit board;
terminal points 3 and 5 are connected to differential data lines of a first interface connector;
terminal points 4 and 6 are connected to differential data lines of a second interface terminal;
the connection points 7 and 8 are connected to a ground potential of the printed circuit board; and
the connection point 9 is connected to the evaluation circuit.

7. A computer system comprising:
a system board, in the form of a printed circuit board according to claim 1, with at least one interface module, at least one multipole pin header electrically connected to the at least one interface module, and a control circuit; and
at least one connection board with at least one internal plug connector that connects the connection board to the at least one multipole pin header of the system board and at least one external plug connector that connects a peripheral device;
wherein said control circuit is configured to prevent full activation of said system board when a predetermined voltage level is applied to a first pin contact of said at least one multipole pin header.

8. The computer system according to claim 7, wherein
the control circuit comprises at least one pull-up resistor;
the first pin contact is connected to a standby voltage via the pull-up resistor; and
the control circuit is configured to prevent the provision of a normal supply voltage if the first pin contact is connected to a ground potential of the connection board via an incorrectly connected cable plug.

9. The computer system according to claim 7, wherein
the system board further comprises a chipset and a power sequencing controller;
the first pin contact is connected to an input connector of at least a portion of the chipset; and
the power sequencing controller scans the voltage level at the input terminal when the computer system is started and activates a normal supply voltage for all components of the system board only if the voltage level indicates that the first pin contact is not electrically connected to a predetermined voltage potential of the connection board.

10. The computer system according to claim 7, wherein the system board further comprises signaling means that indicate an error in starting the computer system, the control circuitry being arranged to signal an error by the signaling means when the predetermined voltage level is applied to the first pin contact.

11. The computer system according to claim 7, wherein the interface module provides at least one data connection according to the USB protocol, and the at least one external connector is a USB connector.

12. The computer system according to claim 7, wherein the at least one internal plug connector of the connection board is a multipole pin header wired equivalent to the at least one multipole pin header of the system board and the at least one multipole pin header of the system board is connected to the at least one multipole pin header of the connection board via at least one cable connection.

13. The computer system according to claim 7, wherein said connection board has a plurality of internal plug connectors and all ground connections of said internal plug connectors are connected to each other.

14. A method of operating a computer system, comprising:
providing a standby voltage;
checking whether a first pin contact of a multi-pin header of a system component of the computer system is electrically connected to a predetermined voltage potential;
providing a normal supply voltage to start further components of the computer system if the first pin contact is not connected to the predetermined voltage potential; and
aborting the starting procedure and preventing the normal supply voltage from being provided at the multipole plug connector if the first pin contact is connected to the predetermined voltage potential.

15. The method according to claim 14, wherein the checking is performed by a power sequencing controller or a BIOS program as part of a power on self test, POST, of the computer system.
